(19) United States
(12) Patent Application Publication
(10) Pub. No.: US 2014/0001229 A1
(43) Pub. Date: Jan. 2, 2014

(54) DRIVER

(71) Applicant: HITACHI KOKI CO., LTD., Tokyo (JP)

(72) Inventors: Kaoru ICHIKAWA, Hitachinaka (JP); Isamu TANJI, Hitachinaka (JP); Syouichi HIRAI, Hitachinaka (JP); Yoshiichi KOMAZAKI, Hitachinaka (JP)

(21) Appl. No.: 13/929,203

(22) Filed: Jun. 27, 2013

(30) Foreign Application Priority Data
Jun. 29, 2012 (JP) 2012-146217

(51) Int. Cl. B25C 1/04

(52) U.S. Cl. CPC B25C 1/047
USPC 227/156

(57) ABSTRACT

A driver which strikes a fastener to drive it into a target object has a cylinder and a driver blade which is reciprocably housed in the cylinder and is driven to reciprocate by pressure of fluid supplied into the cylinder to strike the fastener, and the driver blade is made up of a shaft part and a piston provided at one end of the shaft part and a damping member is incorporated in the shaft part.

### CROSS-REFERENCE TO RELATED APPLICATION

The present application claims priority from Japanese Patent Application No. 2012-146217 filed on Jun. 29, 2012, the content of which is hereby incorporated by reference into this application.

### TECHNICAL FIELD OF THE INVENTION

The present invention relates to a driver which drives a fastener such as a nail or a screw into a target object such as a timber or a drywall.

### BACKGROUND OF THE INVENTION

A driver which strikes a fastener with a reciprocating driver blade to drive it into a timber or a drywall has been known. Japanese Patent No. 3211225 describes a driver using compressed air as a power source of a driver blade.

The driver described in Japanese Patent No. 3211225 is provided with a cylinder which contains a driver blade. The driver blade is pushed down by the pressure of the compressed air supplied to the cylinder and strikes a head of a fastener. Specifically, the driver blade is pushed down by the pressure of the compressed air supplied to a space (upper chamber) above the driver blade in the cylinder and strikes a head of a fastener. At this time, when the driver blade is pushed down to a predetermined position, a part of the compressed air in the upper chamber is exhausted to the outside of the cylinder, and another part of the compressed air in the upper chamber is transferred to a return chamber through a check valve. The driver blade which has struck the head of the fastener is pushed up by the pressure of the compressed air transferred to the return chamber and returns to the original position (initial position).

### SUMMARY OF THE INVENTION

The operation of the driver described above generates the noise and vibration. There are many sources of the noise and vibration, and one example thereof is the vibration of the driver blade. Specifically, when the driver blade strikes a head of a fastener, the driver blade vibrates due to the impact thereof, so that the noise is generated.

Note that Japanese Patent No. 3211225 also mentions the reduction of noise of the driver. However, the matters described in Japanese Patent No. 3211225 relate to the reduction of noise generated at the time of exhausting the compressed air which has pushed down the driver blade (exhaust noise), and Japanese Patent No. 3211225 does not describe and suggest the vibration of the driver blade and the noise generated by the vibration.

An object of the present invention is to reduce the noise of a driver by suppressing the vibration of a driver blade.

A driver according to an aspect of the present invention has a driver blade which is driven to reciprocate by a drive source to strike a fastener, and a damping member is incorporated in the driver blade.

According to the present invention, the vibration of the driver blade is suppressed, and the noise of the driver is reduced.

### BRIEF DESCRIPTIONS OF THE DRAWINGS

FIG. 1 is a cross-sectional view showing an example of a driver to which the present invention is applied;

FIG. 2A is a partial enlarged cross-sectional view of the driver shown in FIG. 1;

FIG. 2B is a partial enlarged cross-sectional view of the driver shown in FIG. 1;

FIG. 3 is an enlarged cross-sectional view of the driver blade shown in FIG. 1;

FIG. 4 is an enlarged cross-sectional view showing a modified example of the driver blade;

FIG. 5 is an enlarged cross-sectional view showing another modified example of the driver blade;

FIG. 6 is an enlarged cross-sectional view showing another modified example of the driver blade; and

FIG. 7 is an enlarged cross-sectional view showing another modified example of the driver blade.

### DESCRIPTIONS OF THE PREFERRED EMBODIMENTS

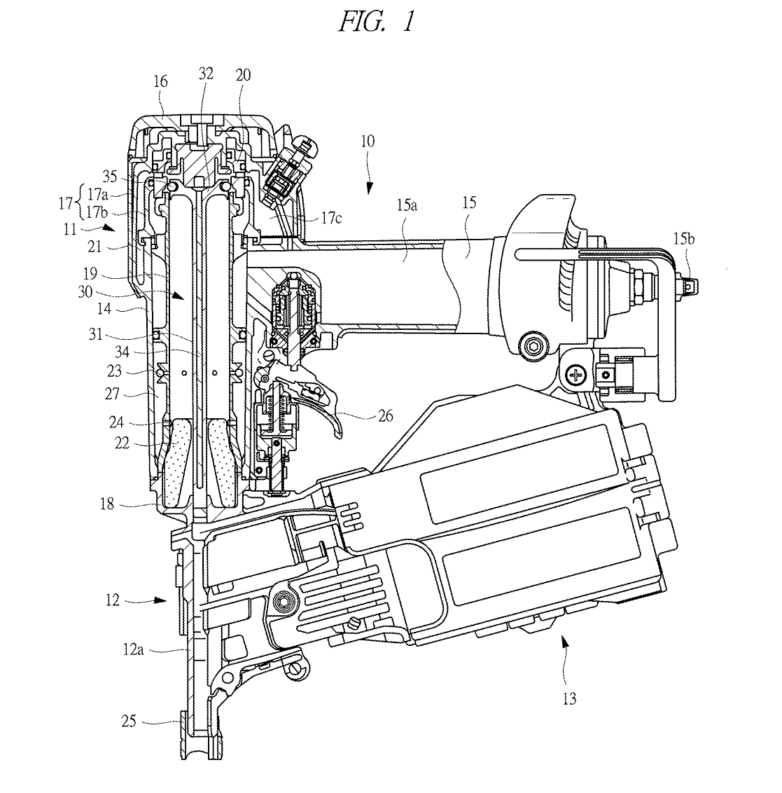

Hereinafter, embodiments of the present invention will be described in detail with reference to drawings. A driver 10 shown in FIG. 1 has a main body section 11, a driving section 12, and a magazine 13.

The main body section 11 has a housing 14, a handle 15, a head cover 16, a guide part 17, and an under cover 18. The housing has a hollow structure. The guide part 17 is provided in an opening on one end side of the housing 14, the under cover 18 is provided in an opening on the other end side, and the head cover 16 is placed on the guide part 17. A cylindrical cylinder 19 is housed in the housing 14. An upper end of the cylinder 19 protrudes through the opening on one end side of the housing 14 and enters the guide part 17.

The handle 15 is apart gripped by a worker who uses the driver 10, and a pressure accumulation chamber 15a is provided therein. One end of the handle 15 is fixed to the housing 14 and the guide part 17, and a plug 15b is provided at the other end of the handle 15. The plug 15b is an air pipe communicating with the pressure accumulation chamber 15a, and is connected to a compressor (not shown) through an air hose (not shown).

The guide part 17 has an outer cylinder 17a and an inner cylinder 17b, and the outer cylinder 17a surrounds the inner cylinder 17b. A main valve 20 which controls the communication between the pressure accumulation chamber 15a and the cylinder 19 is disposed above the cylinder 19 inside the guide part 17 so as to be vertically movable. Also, an expansion chamber 21 is provided between the outer cylinder 17a and the inner cylinder 17b of the guide part 17.

On the other hand, when paying attention to the lower side of the cylinder 19, a damper 22 is disposed from the interior of the cylinder 19 over the inside of the under cover 18. The damper 22 is formed in an approximately cylindrical shape from an elastic rubber. Also, a check valve 23 is provided at the approximate center of the cylinder 19, and a return path 24 is provided below the check valve 23.

In the cylinder 19, a driver blade 30 is housed so as to be moved up and down. The driver blade 30 includes a shaft part 31 and a piston 32 provided at one end of the shaft part 31, and is driven to reciprocate by a pressure of compressed air supplied to and exhausted from the cylinder 19 and strikes a fastener. The driver blade 30 will be described later in detail.

The magazine 13 is a container which contains a number of connected fasteners (nails, screws and others). The magazine 13 is provided with a feeding mechanism which sequentially feeds a number of the contained fasteners to the driving section 12. The driving section 12 has a guide tube 12a which holds the fastener fed by the feeding mechanism at a predetermined position and guides the fastener so as to straighten the driving direction of the fastener. A push lever 25 is provided at a tip end of the guide tube 12a. The push lever 25 can move up and down along the outer periphery of the guide tube 12a, and it moves up when pushed onto the target object to which the fastener is driven and moves down by its own weight or the force from biasing means (not shown) when released from pushing.

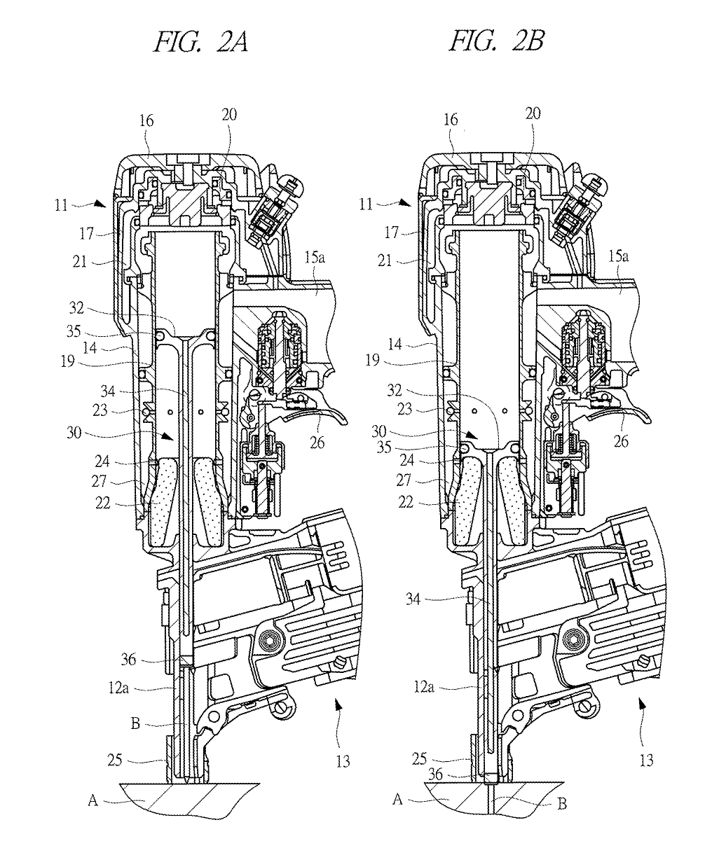

Next, the operation of the driver 10 will be described with reference to FIG. 1 and FIG. 2. Compressed air is supplied to the pressure accumulation chamber 15a through an air hose (not shown) connected to the plug 15b shown in FIG. 1. As shown in FIG. 2A, a worker pushes the push lever 25 onto a target object (timber A in this embodiment) and operates (pulls) the trigger 26. Then, the main valve 20 moves upward to separate from the cylinder 19, and the pressure accumulation chamber 15a and the cylinder 19 are communicated with each other. Simultaneously, the main valve 20 moved upward makes contact with an inner wall of the guide part 17, so that the communication between the cylinder 19 and the expansion chamber 21 is blocked. Then, the compressed air filled in the pressure accumulation chamber 15a flows in the space (upper chamber) above the driver blade 30 (piston 32) in the cylinder 19. As shown in FIG. 2B, the driver blade 30 is pushed down by the pressure of the compressed air which has flown in the upper chamber of the cylinder 19, and strikes the fastener (nail B in this embodiment) held by the guide tube 12a to drive it into the timber A. As described above, in the course of the downward movement of the driver blade 30, the air in the space (lower chamber) below the driver blade 30 (piston 32) in the cylinder 19 is compressed. As shown in FIG. 2A, the air compressed in the lower chamber flows out to the return chamber 27 through the check valve 23 and the return path 24 and is filled in the return chamber 27. As shown in FIG. 2B, when the driver blade 30 further moves down and passes through the check valve 23, the compressed air in the upper chamber which is pushing down the driver blade 30 flows out to the return chamber 27 through the check valve 23 and is filled in the return chamber 27.

Thereafter, when one or both of the conditions of the downward movement of the push lever 25 resulting from the upward movement of the main body section 11 due to the recoil of the driving and the release of the operation of the trigger 26 by a worker is satisfied, the main valve 20 moves downward and returns to the initial position (position shown in FIG. 1). When the main valve 20 returns to the initial position, the main valve 20 makes contact with the cylinder 19 and the communication between the pressure accumulation chamber 15a and the cylinder 19 is blocked, and at the same time, the main valve 20 separates from the inner wall of the guide part 17 and the cylinder 19 and the expansion chamber 21 are communicated with each other. As a result, the compressed air in the upper chamber of the cylinder 19 is exhausted to the outside, and the driver blade 30 is pushed up by the pressure of the compressed air filled in the return chamber 27 and returns to the initial position (position shown in FIG. 1).

When the driver 10 is operated in the above-described manner, the driver blade 30 vibrates and noise is generated. Specifically, the nail B struck by the driver blade 30 is substantially integrated with the driver blade 30 and accelerated to several meters to several tens of meters per second, and then collides with the timber A. The impact of this collision is transmitted to the driver blade 30 via the nail B, and the driver blade 30 vibrates. Also, the driver blade 30 which has moved down to the bottom dead center abuts on the damper 22 and is rapidly decelerated (see FIG. 2B). At this time, the damper 22 and the housing 14 which contains the damper 22 vibrate, and the vibration is transmitted to the driver blade 30 and the driver blade 30 vibrates. Examples of the cause of the vibration of the driver blade 30 have been given here. The driver blade 30 vibrates also by various causes other than those described above, and noise is generated when the driver blade 30 vibrates.

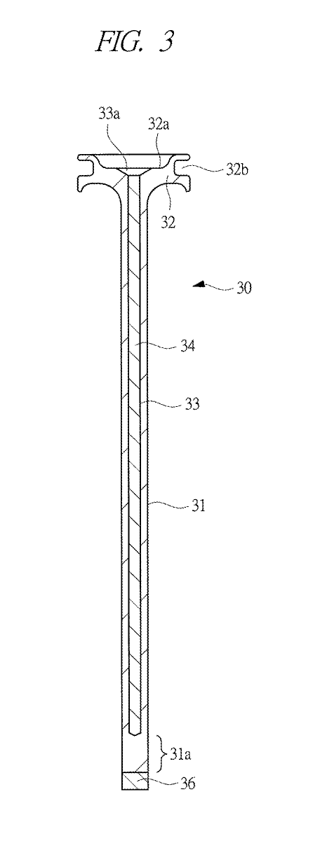

Therefore, a damping member is incorporated in the driver blade 30 used in the driver 10 of the present embodiment. Hereinafter, a structure of the driver blade 30 will be described in detail with reference to FIG. 3.

The driver blade 30 has a shaft part 31 and a piston 32 which are made of steel by integral molding. The shaft part 31 has a rod-like shape whose diameter is 6 mm to 8 mm (8 mm in the present embodiment), and the piston 32 is provided at one end of the shaft part 31 in the axial direction. In the following descriptions, both ends of the shaft part 31 in the axial direction, that is, one end at which the piston 32 is provided and the other end on the opposite side thereof are separately referred to as “base end” and “tip end” in some cases. However, this separation is merely the separation for the sake of convenience.

As shown in FIG. 3, an insertion hole 33 extending in the axial direction of the shaft part 31 is formed inside the shaft part 31. More specifically, the shaft part 31 has a hollow structure. The insertion hole 33 is a bottomed long hole bored from the base end side to the tip end side of the shaft part 31. The insertion hole 33 has an opening on an upper surface 32a of the piston 32, and extends close to the tip end of the shaft part 31 so as to form a solid part 31a on the tip end side of the shaft part 31. A rod-like damping member 34 is inserted in the insertion hole 33. The damping member 34 is made of damping alloy, and is pressure-fitted into the insertion hole 33 from the opening 33a of the insertion hole 33. The damping alloy has various types such as a composite type, a ferromagnetic type, a dislocation type and a twin-crystal type. Any type of damping alloy can be used as the material of the damping member 34, but it is preferable to use the M2052 alloy belonging to the twin-crystal type, which is good in molding processability and has damping characteristics capable of being adapted to a wide variety of stresses.

A ring-shaped trench 32b is formed around the whole circumference of the outer periphery of the piston 32, and an O-ring 35 (FIG. 2) is fitted in this trench 32b. The illustration of the O-ring 35 is omitted in FIG. 3. The O-ring 35 is in tight contact with an inner periphery of the cylinder 19 and maintains the air tightness inside the cylinder 19. When the piston 32 moves up and down in the cylinder 19, the O-ring 35 slides on the inner periphery of the cylinder 19.

On a tip end surface of the shaft part 31, a striking member 36 made of a material (steel in the present embodiment) with a hardness higher than the material of the shaft part 31 is fixed. The striking member 36 has a columnar shape whose diameter is equal to the outer diameter of the shaft part 31, and is disposed coaxially with the shaft part 31. In the present embodiment, the shaft part 31 and the striking member 36 are fixed by the friction pressure welding joint, but the method of fixing them is not limited to any particular method, and they can be fixed also by, for example, gas pressure welding joint and arc welding joint.

As described above, the damping member 34 is incorporated in the driver blade 30 used in the driver 10 of the present embodiment. Therefore, the vibration of the driver blade 30 is suppressed and the noise due to the vibration of the driver blade 30 is reduced. Also, the solid part 31a is provided at the tip end of the shaft part of the driver blade 30 at which strong impact is applied at the time of striking a fastener. Accordingly, the noise due to the vibration of the driver blade 30 can be reduced, while avoiding the reduction of the strength of the shaft part 31.

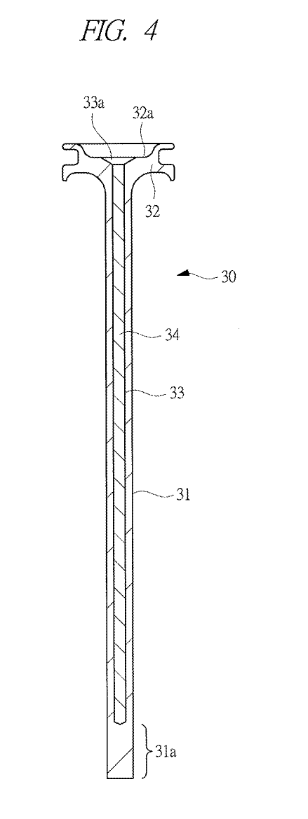

FIG. 4 to FIG. 7 show modified examples of the driver blade. The same components as those which have already been described are denoted by the same reference numerals in FIG. 4 to FIG. 7, and the descriptions thereof are omitted.

In the driver blade 30 shown in FIG. 4, the striking member 36 shown in FIG. 3 is not provided. The strength of the driver blade 30 including the shaft part 31 differs depending on the material and size thereof. Therefore, when the driver blade 30 has sufficient strength by itself, the striking member 36 shown in FIG. 3 is omitted. When the striking member 36 is omitted, the weight reduction of the driver blade 30 and the cost reduction can be achieved.

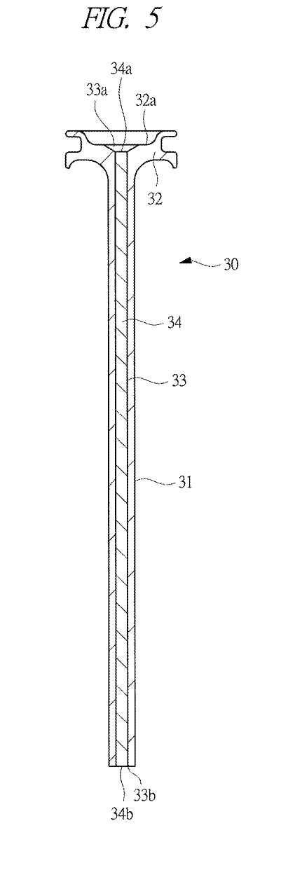

In the driver blade 30 shown in FIG. 5, the insertion hole 33 penetrates through the shaft part 31, and the damping member 34 is inserted over the full length of the insertion hole 33. Therefore, an upper end surface 34a of the damping member 34 is exposed from the opening 33a of the insertion hole 33 which is opened on the upper surface 32a of the piston 32. Also, a lower end surface 34b of the damping member 34 is exposed from an opening 33b of the insertion hole 33 which is opened on a lower end surface of the shaft part 31. In the embodiment in which the insertion hole 33 penetrates through the shaft part 31, air is smoothly evacuated when the damping member 34 is inserted into the insertion hole 33, and the damping member 34 can be easily inserted into the insertion hole 33 in a short time.

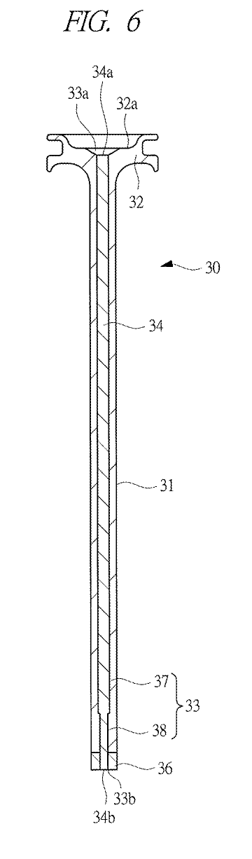

In the driver blade 30 shown in FIG. 6, the insertion hole 33 penetrates through the shaft part 31 and the striking member 36, and the damping member 34 is inserted over the full length of the insertion hole 33. Therefore, the upper end surface 34a of the damping member 34 is exposed from the opening 33a of the insertion hole 33 which is opened on the upper surface 32a of the piston 32. Also, the lower end surface 34b of the damping member 34 is exposed from the opening 33b of the insertion hole 33 which is opened on a lower end surface of the striking member 36. Furthermore, the insertion hole 33 provided in the driver blade 30 shown in FIG. 6 is formed to be a stepped hole in which a large-diameter part 37 and a small-diameter part 38 thinner than the large-diameter part are formed in series along the axis. Furthermore, the small-diameter part 38 is provided at a position closer to the tip end of the shaft part 31 compared with the large-diameter part 37. In other words, the tip end and its adjacent part of the shaft part 31 are formed to be thicker than the other part thereof. Therefore, the strength of the tip end and its adjacent part of the shaft part 31 at which strong impact is applied at the time of striking a fastener is increased. Also in the embodiment shown in FIG. 6, air is smoothly evacuated when the damping member 34 is inserted into the insertion hole 33, and the damping member 34 can be easily inserted into the insertion hole 33 in a short time. Note that, as is illustrated, the outer diameter of the damping member 34 corresponds to the inner diameter of the insertion hole 33, and the outer periphery of the damping member 34 is in tight contact with the inner periphery of the insertion hole 33.

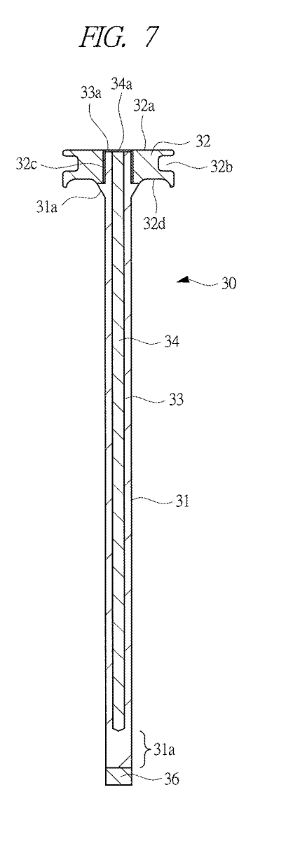

The driver blade 30 shown in FIG. 7 is made up of the shaft part 31 and the piston 32 prepared separately. Specifically, male thread is formed on the outer periphery of the base end of the shaft part 31. On the other hand, an insertion hole 32c is formed at the center of the piston 32 and female thread is formed on the inner periphery of the insertion hole 32c. The shaft part 31 and the piston 32 are fixed and integrated with each other by the thread engagement of the male thread formed on the shaft part 31 and the female thread formed on the piston 32. Note that an annular flange part 31a which abuts on a lower surface 32d of the piston 32 is formed on the outer periphery of the shaft part 31.

The present invention is not limited to the embodiments described above, and various modifications can be made within the scope of gist thereof. For example, the material of the damping member 34 shown in FIG. 3 and others is not limited to damping alloy (M2052), but may be other alloys and be resin or rubber. Also, in the embodiments described above, the damping member 34 formed in a rod-like shape in advance is inserted into the insertion hole 33. Alternatively, it is also possible to fill the insertion hole 33 with a molten material to form the rod-like shape in the insertion hole 33. In other words, it is also possible to form the damping member 34 in the insertion hole 33 by using the insertion hole 33 as a molding die.

Also, the embodiment in which the striking member 36 shown in FIG. 3 is provided at the lower end surface of the shaft part 31 shown in FIG. 5 is included in the scope of the present invention.

In addition, the embodiment in which the striking member 36 shown in FIG. 7 is omitted is included in the scope of the present invention.

Furthermore, in the driver 10 of the embodiments described above, the pressure of the compressed air supplied from a compressor is used as a drive source of the driver blade 30. However, a driver which uses fluid pressure generated by the combustion of gas or powder as a drive force of the driver blade is also included in the scope of the present invention. Moreover, a driver which uses an electric motor or the like as a drive force of the driver blade is also included in the scope of the present invention.

What is claimed is:

1. A driver having a driver blade which is driven to reciprocate by a drive source to strike a fastener,
wherein a damping member is incorporated in the driver blade.

2. The driver according to claim 1 comprising:
a cylinder; and
the driver blade which is reciprocably housed in the cylinder and is driven to reciprocate by a pressure of fluid supplied into the cylinder,
wherein the driver blade includes a shaft part and a piston provided at one end of the shaft, and the damping member is incorporated in the shaft part.

3. The driver according to claim 2,
wherein an insertion hole extending along an axis of the shaft part is formed in the shaft part, and the damping member is inserted in the insertion hole.

4. The driver according to claim 2,
wherein a striking member made of a material with a hardness higher than a material of the shaft part is provided on a tip end surface of the shaft part.

5. The driver according to claim 3,
wherein a striking member made of a material with a hardness higher than a material of the shaft part is provided on a tip end surface of the shaft part.

6. The driver according to claim 3,
wherein the insertion hole penetrates through the shaft part.

7. The driver according to claim 4,
wherein the insertion hole penetrates through the shaft part and the striking member.

8. The driver according to claim 5,
wherein the insertion hole penetrates through the shaft part and the striking member.

9. The driver according to claim 6,
wherein the insertion hole is a stepped hole in which a large-diameter part and a small-diameter part thinner than the large-diameter part are formed in series along the axis, and the small-diameter part is provided at a position closer to a tip end of the shaft part compared with the large-diameter part.

10. The driver according to claim 7,
wherein the insertion hole is a stepped hole in which a large-diameter part and a small-diameter part thinner than the large-diameter part are formed in series along the axis, and the small-diameter part is provided at a position closer to a tip end of the shaft part compared with the large-diameter part.

11. The driver according to claim 8,
wherein the insertion hole is a stepped hole in which a large-diameter part and a small-diameter part thinner than the large-diameter part are formed in series along the axis, and
the small-diameter part is provided at a position closer to a tip end of the shaft part compared with the large-diameter part.

12. The driver according to claim 3,
wherein the insertion hole has an opening on a side of the piston of the driver blade, and extends close to a tip end of the shaft part so as to form a solid part on the other end side of the driver blade.

13. The driver according to claim 4,
wherein the insertion hole has an opening on a side of the piston of the driver blade, and extends close to a tip end of the shaft part so as to form a solid part on the other end side of the driver blade.

14. The driver according to claim 5,
wherein the insertion hole has an opening on a side of the piston of the driver blade, and extends close to a tip end of the shaft part so as to form a solid part on the other end side of the driver blade.

15. The driver according to claim 1,
wherein a material of the damping member is any one of damping alloy, rubber and resin.
